(19) United States
(12) Patent Application Publication
(10) Pub. No.: US 2010/0306732 A1
(43) Pub. Date: Dec. 2, 2010

(54) CORRECTNESS BY PROOF

(76) Inventor: Jerry Zhu, Glen Allen, VA (US)

Correspondence Address: Jerry Zhu, 10805 Hinton CT, Glen Allen, VA, 23060, US

(21) Appl. No.: 12/775,673

(22) Filed: May 7, 2010

Related U.S. Application Data
(60) Provisional application No. 61/216,863, filed on May 26, 2009.

(51) Int. Cl. G06F 9/44

(52) U.S. Cl. 717/105; 717/100; 717/104

(57) ABSTRACT

A methodology and system for defining enterprise software requirements is provided. The methodology, called correctness by proof, is based on biology of cognition and mathematical logic. The methodology decomposes requirements engineering problem into three standalone sub-problems each of which is solved using axiomatic method to construct an axiomatic theory. The whole of enterprise software requirements is represented as three hierarchically organized axiomatic theories. Every theorem of an axiomatic theory is proved to be true, resulting all requirements correct by construction. Requirements constructed in form of axiomatic theories have three attributes: consistent (free of contradiction), complete (no missing requirements) and normalized (free of redundancies) as ensured by the properties of axiomatic systems. This proposed innovation anticipates immediate benefits for a discontinuous progress in defining correct and precise requirements by construction impossible with today's approaches. It also expects to reshape the landscape of requirements definition technologies to automate tasks with scientific exactitude.

### RELATED APPLICATION

This application claims the benefit under Title 35, U.S.C. §119(c) to U.S. Provisional Application Ser. No. 61/216,863, entitled “Discipline and System for Enterprise Software Requirements Modeling and Management” by Jerry Zhu, filed on May, 26, 2009, which is herein incorporated in its entity by reference for all purposes.

### FIELD OF THE INVENTION

The present invention pertains to software development. More specifically, the present invention relates to methods and systems for defining enterprise software requirements that have three attributes: consistent (free of contradiction), complete (no missing requirements), and normalized (free of redundancy) prior to coding.

### BACKGROUND OF THE INVENTION

Issues with Current Requirements Engineering Practice

One traditional way of documenting requirements, according to Wikipedia, has been contract style requirement lists that can run into hundreds of pages for a fairly complex system. This extremely long shopping-list like requirements are very much out of favour in modern analysis; as they have proved spectacularly unsuccessful at achieving their aims. Issues of requirements lists are plenty and some are listed below:
1. They focus on the system, what the system shall do, rather than on the understanding of the business, leading to business and software misalignment.
2. They do not transform into design specification, since they do not lend themselves to application.
3. High overhead cost, diluting important design issues by carrying around the excess baggage of all these shall statements and dealing with traceability, testability, documentation and so on.
4. False sense of mutual understanding between the stakeholders and developers and false sense of security that the developers must achieve certain things.
5. Lack of structural relationship as how the requirements fit together, their dependencies and order of implementation
6. No way of knowing what crucial requirements are missed out until later in the process. Developers can use these discovered requirements to renegotiate the terms and conditions in their favour.
7. They are imprecise, inconsistent and redundant as the more people read such requirements the more different visions of the system you get.

An alternative solution to the requirements analysis problem is rapid prototyping to build a mockup system. The mockup system simulates the important interfaces and performs the main functions of the intended system, while not necessarily being bound by the same hardware speed, size, or cost constraints. The purpose of the prototype is to make real the conceptual structure specified, so that the client can test it for consistency and usability. It allows users to visualize an application that hasn't yet been constructed. Prototypes help users get an idea of what the system will look like, and make it easier for users to make design decisions without waiting for the system to be built. Major improvements in communication between users and developers were often seen with the introduction of prototypes. Early views of applications led to fewer changes later and hence reduced overall costs. However, while proving a useful technique, prototyping did not solve the requirements problem according to Wikipedia:
1. Prototyping is an overhead and often discarded. Designers often feel compelled to use patched together prototype code in the real system, because they are afraid to ‘waste time’ starting again.
2. Prototypes principally help with design decisions and user interface design. However, they can not tell you what the requirements originally were.
3. Designers and end users can focus too much on user interface design and too little on producing a system that serves the business processes.
4. Prototypes work well for user interfaces, screen layout and screen flow but are not so useful for batch or asynchronous processes which may involve complex database updates and/or calculations.
5. Prototyping can be useful in some projects but it is merely a technique of art and contributes nothing to software engineering becoming an engineering discipline.

### The Software Industry Problem

Software industry has a problem, an engineering problem shared by all software companies. The problem is being incapable of determining precisely what to build before building it, resulting in highly defective, less generic, and hard-to-maintain software. This problem causes many other problems:
1. Development begins without adequate product requirements.
2. Imprecise practice of generating time estimates for software projects.
3. Lack of engineering discipline where the number ways to design and program are as many as the number of programmers.
4. Uncontrolled intellectual rework. 25-40% of all spending of projects is wasted in intellectual rework. Every instance of rework introduces a sequential set of tasks that must be redone. Attempts to fix an error often introduce new ones. Too many errors can swamp the project.
5. High overhead cost. Overhead activities are non-value adding such as planning, monitoring, risk and quality management, testing, rework, and administration etc. Productive activities are value adding such as defining requirements, analysis, design, coding, and deployment etc. Cost effectiveness is measured by O/P ratio, the cost of overhead activity being divided by the cost of productive activity. The higher O/P-ratio the lower cost effectiveness. Current prevailing O/P ratio value is 4.

The consequences of the problem are many. They are budget overrun, schedule delays, and misalignment between business and software. If a company cannot determine precisely what software is supposed to do, how can it develop a product that meets customer needs on budget and on schedule? Two things happen when the team delivers a boat while customer wants a car:
Cancel the project. 18% of software projects are canceled. You loose lots of money.
Fix it. You will need to pay extra to fix it. By fixing it, it meets your needs better. But it may not meet all your needs. You may want to use it for a while to know your needs better and how to fix it in maintenance phase. The project is challenged. 59% of projects are challenged. There is a risk. The cost of fixing it may be higher than starting from scratch.

Requirements volatility means rework that delays schedule and consumes staff effort. Developers on average spend 40% of their time fixing requirements-related errors [NIST, 2002]. If you're budgeting $500,000, you're spending about $200,000 fixing defects that originate in your requirements.

Because requirements we are managing and tracing today are fraught with errors, we need to improve them. It will cost you for not finding and fixing bad requirements as soon as possible. The cost to repair missing, erroneous, incomplete, inconsistent, or ambiguous requirements grows exponentially as your product development lifecycle proceeds. It's much cheaper to detect and fix errors earlier. Currently there are two ways to reduce requirements errors:
Improved testing infrastructure eliminates a third of requirements error induced costs by enabling earlier and more effective identification and removal of software defects [NIST, 2003]. But investing in testing infrastructure also introduces costs. It is difficult to predict whether or how much this investment will offset the cost.
Improved requirements validation reduces requirements errors as they are created as opposed to testing the code when bad requirements are already converted into code. There are few requirements validation software tools in the market and their effectiveness is not apparent.

Both can reduce requirements errors in limited way but none claims to eliminate them while increasing significantly overhead cost. The fundamental problem is not in flawed requirements and how to fix them, but it is in our methods. Can we develop a new method with which requirements are created free of error in the first place? To answer this question, we need to know what is the root cause of software industry problem to be able to solve it. It is the epistemic fallacy of software engineering.

### The Epistemic Fallacy of Software Engineering

Engineering activity is epitomized by two concepts: epistemology and ontology. Ontology is the study of being, of what exists and of what is think-able. It determines what types of entities constitute reality. Ontology questions the real nature of entities, how do they come into being and why. Epistemology refers to how we know what we know. Therefore, rather than focusing on the object of the investigation, it concentrates on how knowledge can be acquired on the entities being examined. This means that epistemology has to do with methods: theories, concepts, rules and the procedures applied within a discipline in order to derive at knowledge to construct the entities defined in the ontology.

Questions about the nature of the subject, what entities exist, and what artifacts to create are ontological questions. Questions about how to create what we think we know about the subject, entities, or artifacts are epistemic questions. Ontology precedes epistemology. We must know first the world as such and such in order to create the world as such and such. Epistemic fallacy reduces ontological questions to epistemic questions. It assumes that for any question of whether or not such and such exists or what to create, we should substitute the question for how we know or create what such and such exist. Without knowing what a car is and start building it, we may end up with a boat or go through extensive changes in the process. Requirements change and rework can be completely eliminated if epistemic fallacy is eliminated when we are able to define ontology in its entirety and then proceed to epistemology.

Today's prevailing software development methodologies are epistemic fallacies because they do not begin with the understanding of the problem first in order to understand the system as a conceptual whole before creating it. Only when ontological questions about enterprise software are answered with satisfaction, shall we proceed to answer epistemic questions about constructing enterprise software. They begin with requirements defined as what should be in the system, the solution, rather than the problem in the context in which the system is used. It intends to understand the system through trial and error of building the parts iteratively. Building and delivering some rooms early and making changes to them along the way to understand what house we need in the process rather than having a blueprint of the house before the ground is touched. The prevailing strategy in today's market is to build something for users to try out. Only then will we discover what really should have built. The users will be disappointed, but maybe we can do better with the second or later versions. This severely limits to the possibilities to our approach. The good news is that the ontology of enterprise software already exists and we can proceed to answer epistemic questions precisely according to this ontology. This invention is to disclose the enterprise software ontology that is built on biology of cognition, or the theory of Autopoiesis and enterprise software epistemology that is built on mathematical logic.

Phillip G. Armour, in his book “The Laws of Software Process,” said, “Software is not a product. The product is not software, it is knowledge contained in software . . . then software development can only be a knowledge acquisition activity. Coding is only a small part of the software activity, and it is getting smaller . . . . We can reasonably assert that if we already have the knowledge, then transcribing it does not require much effort.” Knowledge contained in software is the thing-in-itself independent of software. Rather, software depends on the knowledge. Logically, we shall be able to acquire complete knowledge before writing software. But this in fact is impossible with today's SE theory and practice. Enterprise software ontology describes the organization of this knowledge that serves as the framework whereby ontological questions are answered.

The invention anticipates a complete solution of requirements engineering for enterprise software with a science-based methodology called Correctness by Proof (CbyP). In contrast, today's approach is intuition-based. There are two types of knowledge: scientific and intuitive. The two types of knowledge are different. Scientific knowledge is defined as knowledge created by scientific method organized by general principles with mathematics as its basis. In our case, the mathematics is the axiomatic theory. Every axiomatic discipline is a mathematic discipline and every mathematic discipline is an axiomatic discipline. The principles include consistency, completeness and independence of axiomatic theories. Intuitive knowledge is defined as knowledge created by sense perception or intuition without inference or the use of reason. Intuition provides us with beliefs that we cannot necessarily justify. Knowledge acquires its most developed and perfected form in science. Scientific knowledge is communicable. Physics can be learned in classroom or self taught. No matter who and where on earth, what is learned is the same physics. Hence the knowledge of physics is communicable. Knowledge that cannot be communicated is intuition. By being incommunicable, it means that the more people read the knowledge the more different visions of the knowledge you get. By being communicable, no matter how many people read the knowledge, there will be only one vision of the knowledge you get. Scientific knowledge is precise and economical while intuitive knowledge is imprecise and wasteful. The design of a structure or a mechanical device to carry maximum loads or perform a specific function, for instance, is the most precise and economical when scientifically designed while imprecise and wasteful when designed on the basis of intuition. CbyP has its methods based on science hence dissolves problems inherent to today's prevailing methodologies. With CbyP, we are able to create complete requirements in form of scientific, as opposed to intuitive, knowledge that is communicable. Because all enterprise software shares a common ontology whereby tasks, quality, and performance criteria are defined. Therefore, a generic methodology is possible to put an end to the myriad of methodologies currently seen in the marketplace.

### Enterprise Software as a Living Organization

Enterprise software solves enterprise problems as opposed to workers' problems. Only an enterprise can solve enterprise problems. Therefore enterprise software is an organization within an organization, having itself customers, human and nonhuman agents, systems, and administrative functions constrained by the containing organization.

According to Wikipedia: “Enterprise level software is software which provides business logic support functionality for an enterprise, typically in commercial organizations, which aims to improve the enterprise's productivity and efficiency.” Enterprise software, also called enterprise level application software, performs business functions such as accounting, production scheduling, customer information management, bank account maintenance, etc. Enterprise software is often categorized by the business function that it automates—such as accounting software or sales force automation software. Similarly for industries—for example, there are enterprise systems devised for the health care industry, or for manufacturing enterprises. It is frequently hosted on servers and simultaneously provides services to a large number of enterprises, typically over a computer network. This is in contrast to the more common single-user software applications which run on a user's own local computer and serve only one user at a time.

Enterprise software supports the mission for which it's built. For example, it should provide value to the business by offering products and services to its customers, including external and internal (e.g. organizational units and other systems) customers. Therefore, enterprise software is an organization within an organization, having itself customers, workers, technologies, systems, and administrative functions constrained by the containing organization.

Enterprise software, as a social organization, is a living unity that is born to life, grows, moves from place to place, communicates with other unities in its environment, changes with time, and dies. Viewing enterprise software as a living system allows us to incorporate the ideas from the theory of Autopoiesis [Maturana and Varela, 1992]. Below are some critical concepts about Autopoiesis.

Organization vs. structure—Organization denotes those relations that must exist among the components of a system for it to be a member of a class. Structure denotes the components and relations that actually constitute a particular unity and make its organization real. Organization serves the identity that is maintained in spite of dynamic changes over time. The ‘particulars’ of a given class's individual member's realization make up its structure.

Structural coupling—A living being is born to an initial structure in a particular place, in a medium that constitutes the ambience in which it emerges and interacts. This ambience appears to have a structural dynamics of its own, operational distinct form the living being. We have thus distinguished two structures that are going to be considered operationally independent of each other: living being and environment. Between them there is a necessary structural congruence as a result of historical recurrent interactions.

Cognition —Living systems are cognitive systems, and living as a process is a process of cognition. A living system is organizationally closed, autonomous, and self-referential. It means that the pattern of interaction with the environment is internal not external determined. A living system structurally represents its environment and specifies its interactions with the environment internally. In other words, it brings forth a world by specifying what patterns of the environment are perturbations and what changes trigger them in the system. Therefore, a cognitive system internally represents the organization of the environment and specifies its interactions with this organization. For bacteria, this representation is implemented in its molecular structure. For organisms with nervous systems, this representation is implemented in the network of neurons. For social organizations, this representation is implemented in organizational design where agents and processes are defined. In this sense, social organizations are more akin to bacteria instead of multi-cellular organisms.

Enterprise software is a living system comprising human and nonhuman agents and these agents interact forming a network. There is a structural coupling between the structure of the network and the structure of its environment. The structure of the agent network is formed in such a way that it stores information about its environment and information about interactions between itself and its environment. That is, the two types of information are encoded into the structure of the agent network. Therefore a living system is represented as three-level models. They are from bottom up environment, interaction, and network models. The upper level model deals with the structure of the lower models.

The software system to be developed is also a living system residing within the enterprise software. The environment of the software system is the agent network of the enterprise software. Similarly the software system will also represent its environment within and specifies its structural coupling with the environment. Both enterprise software and its embedded software systems are cognitive systems hence we can describe them in terms of Autopoiesis. Together, enterprise software is modeled in five levels with the agent network being the environment of the software system. Each level is described by the concept of domain.

### Domain

A key concept in Autopoiesis is domain. A domain is a description for the “world brought forth,” a circumscription of experiential flux via reference to current states and possible trajectories. Domains are most typically introduced to circumscribe exclusive realms or sets, i.e., they serve as categorization constructs for sorting out unities and phenomena. The functional definition of domains by the unities and/or relations constitutive of them makes them definitional constructs that generate their own discrete referential extent. This definitional reliance upon the constitutive elements provides a basis for differentiating domains in terms of differentials among unities and/or relations. The models we create belong to certain domains.

There are Five Domains into Which our Models Fall:
1. Enterprise domain: collective sets including a set of customers (internal organizational units and external organizations or individuals), a set of others systems, a set of products and services the customers receive, a set of business rules, and a set of artifacts interacting with other systems receive.
2. Business domain: the set of end-to-end business processes or interactions between the enterprise software and its environment, the enterprise domain.
3. Agent domain: collective sets, including a set of human and technical agents, a set of actions between these agents, a set of data produced in these actions, and a set of quality constraints.
4. Functional domain: a set of software functions required by the agent domain, data flows among these functions and a set of interface components with which the agents interact.
5. Systems Domain: the set of software components that implement the functional domain.
   The sets within each domain are not meant to be complete. They serve as starting place whereby new sets may be added when discovered. Each of the five domains may contain sub domains.

### Ontology

An ontology is a formal representation of entities, ideas, and events, along with their properties and relations, according to a system of categories. It is used to reason about the properties of that domain, and may be used to describe the domain or a system of domains. Most ontologies describe individuals (instances), classes (concepts), attributes, rules, and relations. A domain ontology (or domain-specific ontology) models a specific domain, or part of the world. The ontologies of the five enterprise software domains are represented as five models. They are enterprise, business, agent, functional, and system models. Agent domain describes the constituents of the enterprise software that communicates with its real world using a language. The syntax and semantics of the language are enterprise model and business model respectively. Similarly, system domain describes the constituents of a software system that communicates with its real world that is part of agent domain using a language. The syntax and semantics of the language are agement model and functional model respectively. The syntax defines the real world and the semantics interprets the syntax in relating the living system that speaks the language.

When the five domain ontologies are clearly defined and understood, we obtain ontological commitments for a set of agents or workers so that they can communicate without necessarily operating on a globally shared theory. We say that an agent commits to ontology if its observable actions are consistent with the definitions in the ontology. Pragmatically, a common ontology defines the vocabulary with which queries and assertions are exchanged among agents. Ontological commitments are agreements to use the shared vocabulary in a coherent and consistent manner. The agents sharing a vocabulary need not share a knowledge base; each knows things the other does not, and an agent that commits to ontology is not required to answer all queries that can be formulated in the shared vocabulary. Ontological commitments guarantee consistency of work products, but not completeness, with respect to queries and assertions using the vocabulary defined in the ontology. Completeness is ensured by the epistemology that all artifacts at a level to which artifacts at the level above are traced to.

### Enterprise Software Ontology

When a living unity interacts recurrently with its environment that may contain other living systems, it generates a social coupling. Behaviors that take place are communicative that are learned. The mechanism of the social coupling among social insects takes place through the interchanges of substances. Therefore it is chemical coupling. For the social couplings between social organizations and software systems, the mechanism takes place through the interchanges of formulas. A formula is a text or diagram constructed from predefined symbols combined according to explicit rules. A good working definition of formula is anything whose appearance or syntax can be checked by a computer. According to this definition, every computer program is a formula. Therefore we construct the five domain ontologies of enterprise software by using formulas and notations as raw materials. These materials are the substances of a language that the living (enterprise software or software systems) being speaks.

In the recurrent social interactions among living systems, language appears. The whole language can be fragmented into three individually understood parts. If we abstract from the speaker and analyze only the expressions and their designata, we are in the field of semantics. If we abstract from the designata also and analyze only the relations between the expressions, we are in syntax. If the investigation's explicit reference is made to the speaker of the language and describes the effects caused to the speaker or the makings of the speaker, we assign it to the field of pragmatics. The whole science of language, consisting of the three parts mentioned is called semiotic.

For the language that enterprise software speaks, the enterprise domain ontology is the syntax, the business domain ontology is the semantics, and the agent domain ontology is the pragmatics. For a software system within the enterprise software, its syntax is a subset of agent domain ontology. Functional domain ontology is the semantics. For the scope of requirements engineering problem, we stop at functional ontology that describes the whole of requirements documentation sufficient to the development of software system.

The five domain ontologies and their relationships constitute the five-level ontology of enterprise software. It is ontological non-reductionist theory of levels of reality which includes the concept of emergence, The five levels bottom up are enterprise, business, agent, functional, and system domain onotologies. The concept of emergence is the creation of new levels, new entities and new properties that can not be predicted from the properties found at the lower levels. Relationship between levels are inclusive, permitting the “local” existence of different ontologies. That the levels are inclusive means that a lower level is a necessary condition for the higher level, and that the higher level supervenes upon the lower. It means that a higher level does not violate lower level laws, that higher level is materially related to the lower one, and that does not imply that the organizing principle of the higher level can be deduced from lower level laws. The emergence implies a bottom up sequential evolution that the development of the lower level precedes that of the higher level. Emergence means that new matter is created that can neither be predicted nor automated and the levels can not be skipped.

The five domain's ontologies describe what to construct as compositions of formulas. The inclusiveness between the five ontologies indicates that the higher level ontology deals with the structure of the lower level ontology by having a structure of its own. Each of the five domain ontologies consists of a structure of formulas. The discipline of constructing the five domain ontologies belongs to episteomology. In this invention we use the discipline of mathematics as the discipline of epistemology.

### Axiomatic Method as Epistemology

Once the ontology of the enterprise software is precisely detailed, next is to define epistemology. Epistemology comprises methods, concepts and tools etc that are used to construct or develop enterprise software along the defined ontology.

In mathematics, an axiomatic system consists of a set of axioms and a set of rules that can be used in conjunction to logically derive theorems. A mathematical theory consists of an axiomatic system and all its derived theorems. In a axiomatic system, we accept axioms and rules as true without in any way establishing their validity. On the other hand, we agree to accept any other statements as true only if we have succeeded in establishing its validity, and to use while doing so, nothing but axioms and rules, definitions, and statements of the discipline the validity of which has been established previously. As is well known, statements established in this way are called proved statements or theorems and the process of establishing them is called a proof. More generally, if within logic we establish one statement on the basis of others, we refer to this process as a derivation or deduction, and the statement established in this way is said to be derived or deduced from the other statements or to be their consequences.

The method of constructing an axiomatic theory or a mathematical discipline, the axiomatic method, has four steps:
1. Identify primitive/defined terms or glossary
2. Define axioms
3. Define rules for deducing theorems
4. Derive theorems

Axioms concern the subject matter under study, while rules of inference concern the logic. In the case of engineering, the axioms constitute requirements, the theorems are the solution, and the rules are the environmental constraints. Mathematics is expanding its domain in width since its methods permeate other branches of sciences, while its domain of investigation embraces increasingly more comprehensive ranges of phenomena and ever-new theories are being included in the large circle of mathematical discipline. If software engineering is expected to become a scientific discipline, that discipline is an axiomatic discipline and all axiomatic disciplines are mathematical disciplines.

A decisive point is the holistic conception of language, as a whole of description-interpretation processes that are entangled in the language itself [Lars Lofgren, 2004]. For every language there is a linguistic complementarity. The syntax is the description and the semantics is the interpretation. The more capable the description, the more effective and economical the interpretation will be. The predictive power will increase if the description is simple. The shorter the description is made, the more communication power it will be, and the more genuine will the learning be. This entangled description-interpretation complementarity constitutes an axiomatic theory with the syntax as the axioms and the semantics as theorems.

For a living system, its syntax and semantics together constitute the whole of its requirements expressed as an axiomatic theory. We may call it requirements theory. Enterprise software is a business organization, a living system having software systems, other living systems, embedded within. Each of two types of living system has a requirements theory. They are business and system requirements theories respectively. We first create business requirements theory for the enterprise software from which the agent network is derived. The agent domain ontology becomes the environment of the software systems whereby system requirements theories are created. System requirements theory contains the whole of requirements sufficient for developing the software system in its entirety.

By constructing enterprise software requirements artifacts (i.e. business processes, use cases and functional requirements, business rule etc.) as axioms and inference rules of axiomatic systems along the enterprise software ontology, requirements artifacts are logically organized in form of axiomatic theories at different levels of abstraction. Using axiomatic method, CbyP creates axiomatic theories that unite requirements into a single structure. Axiomatic method ensures exactness of the concept employed, certainty, consistency, and conclusiveness in the argument, and excludes placement of personal opinions, vagueness, and flexibility in concepts. Hence the conclusion can be easily reached that this method simply serves in science the full logical substantiation and final shaping of the content of the scientific cognition, and that, by its nature, is alien to those imprisoned in the assumptions of today's prevailing methodologies. As such requirements artifacts as a whole has all the properties of an axiomatic system. These properties are ensured by mathematical logic as embodied by the methodology. These properties are described below.
Consistent—an axiomatic theory is consistent if no two derived theorems contradict each other.
Completeness—an axiomatic theory is complete if every theorem is provable hence every theorem is traced back to an axiom.
Independent—an axiom is called independent if it is not a theorem that can be derived from other axioms in the system. This concept is equivalent to the concept of normalization in database design where requirements are organized as a hierarchical database.

Requirements having the above three properties are quality requirements that are both coherent and correct. The correctness of all requirements artifacts is ensured by logic as long as the enterprise domain model is correct. Coherence means full traceability of elements between the all models. Coherent model demonstrates the greatest economy to reduce the steps of development to the smallest number. Coherence ensures precise, concise, and complete modeling. All useful things are created once and every thing created is useful. Coherent truth is about the truth of statements. A domain model (theorems) is true as long as the domain model below (axioms) is true. Therefore, it is the enterprise domain model that sets the boundary and scope of the system under development. Developing sound enterprise domain model is critical to software development in any application domain regardless of industry and size of projects. The good news is that the task of developing a sound enterprise domain model is remarkably simple, objective and systematic with subjective certainty. If not, the project should abort without further investment.

The requirements artifacts described in CbyP focus on functional requirements without considering nonfunctional requirements such as safety, security, availability, and reliability etc. Non-functional requirements impact system architecture but they are customized or cannot be represented as a reference model generic to all domains of application. Functional requirements are entities and nonfunctional requirements are attributes of these entities. Hence nonfunctional requirements depend on functional requirements. Correct functional requirements are a necessary condition to derive correct nonfunctional requirements. The invention ensures correct functional requirements from which nonfunctional requirements are further derived.

The completeness property has profound implications, the possibility of constructing adequate product requirements before development begins. As such, we are able to know precisely what to build before building it, solving the software industry problem. All this means that software solution buyers, particularly governments, can have two-phase procurement: requirements phase and development phase. The two phases require different skill sets and use different disciplines. Dividing a complex problem into two standalone sub-problems simplifies procurement process, increasing transparency and subjective certainty, and reducing cost and risk.

In summary, software industry has a requirements instability problem. This problem is caused due to the epistemic fallacy committed by the prevailing development methodologies in the marketplace. There is a need in the field of software engineering a new discipline to overcome the epistemic fallacy that will, in turn, solve the software industry problem and put myriad methodologies to an end. There is a need to increase the maturity of software engineering by introducing and applying the science of software. The science of software, based on the biology of cognition [Maturana and Varela, 1992] and mathematical logic, is used to logically derive correct requirements by proof. With the application of mathematical logic, we are able to describe precisely what can be automated and what must be performed manually in the entire software development lifecycle whereby software technologies can be precisely defined. In contrast, today's prevailing methodologies are based on opinions hence there exists a huge waste in resources spent on rework due to poor requirements. Furthermore, the new discipline can be effectively accepted and enforced only when science based software requirements development tools are presented and provide users the ability, at early phase of the development cycle, to successfully define, model, and manage requirements. The use of these scientifically designed tools will automate all that can be automated and offers conceptual assistance to tasks that cannot be automated.

It is an objective of the invention to propose a scientific discipline of software requirements engineering, called Correctness by Proof (CbyP), whereby requirements engineering problem is solved with subjective certainty and scientific exactitude. The use of the scientific requirements engineering discipline will create quality requirements that are consistent, complete, and normalized. It is still another objective of the invention to design and implement a system of requirements definition and management tools. This system of tools enforces the discipline, guide complex tasks and automate repetitive procedures. It integrates requirements definition and management into a seamless solution.

### SUMMARY OF THE INVENTION

A system and methodology is provided which allows requirements engineers to define and manage software requirements in an error free and expedient manner that solves the requirements volatility problem, eliminating requirements change and rework. According to one embodiment of the invention, a system and methodology is provided which allows a requirements engineer to decompose requirements engineering problem into three standalone sub-problems. Each of the three problems is solved in isolation using a system and method, significantly reducing the complexity of requirements engineering problem. More specifically, the system and methodology allows a requirements engineer to define five domain ontologies, relate them into three axiomatic theories and then apply axiomatic methods to produce these theories. The axiomatic method to construct axiomatic theories presupposes disciplines including set theory, organization theory, business process notation, and Unified Modeling Language as appropriate. The three theories constitute the whole of enterprise software requirements that are consistent, complete, and normalized.

According to an embodiment of the invention, the computer system performs a step of constructing enterprise model and business rules. According to another embodiment of the invention, the computer system performs a step of constructing business requirements theory having two levels of models: enterprise and business. According to another embodiment of the invention, the computer system performs a step of constructing business theory meeting the business requirements. According to another embodiment of the invention, the computer system performs a step of constructing system requirements theory having two levels of models: agent and functional. According to another embodiment of the invention, the computer system performs a three-dimensional requirements visualization and change impact analysis at any point within the requirements structure. According to another embodiment of the invention, the computer system allows an administrator to perform many administrative tasks such as configuration management, support functions including model checking and reporting, and assigning roles.

The three solutions corresponding to three sub-problems of requirements engineering are three axiomatic theories, each of which is constructed through creating a new axiomatic system and a proof of its theorems. This sequential theory building along the enterprise software ontology is served as a conceptual apparatus that would supply a common basis for the scientific discipline of requirements engineering. The underlying axiomatic method is regarded as the sole permitted means of establishing truth, and an indispensable auxiliary tool for deriving conclusions from accepted assumptions. It indicates that we can define enterprise software requirements systematically bottom up without scrap and rework, determining precisely what to build before building it as opposed to building it in order to know what to build and then rebuild it and so on.

The methodology, CbyP proposed in this invention, is entity-based as opposed to people or process based. Entities are artifacts produced in engineering processes and have an extended lifetime throughout software lifecycle. That is, entities are things that persist rather than ephemeral objects that are transiently introduced within the process. Artifacts produced in management process such as project plan and test plan etc, for example, are not entities because they are discarded when the development life cycle completes. Entities are stable intermediate forms passed to next task in the development lifecycle, or future enhancement projects, hence persist throughout product life cycle. Entities are constituents of enterprise ontology and they are stable within the project lifecycle. Scrap and rework, which are common in process-based and people-based processes, are eliminated in entity-based process. This is because work coordination for entity-based process is based on the quality status of entities rather than on the rigidity of the process or people's subjective opinion. Therefore it is the entity structure, or ontological models, organizing the flow of activities and people as opposed to process or people structure organizing the flow of artifacts. Entity-based process places the quality artifacts at the center and reduces the process steps to the smallest number.

The five domain ontologies are represented in five models constituting the whole of entities to be produced. These models describe the problem and solution spaces with varying degrees of abstraction. These models are built hierarchically with higher-level ones depending on the lower ones. Each model is described in its own concept and symbols using different modeling notations and tools. Development process is to transform the models sequentially from enterprise domain to software system domain.

A distinct advantage of entity-based development is that its work breakdown structure (WBS) is based on the enterprise software ontology to build models level by level from the most abstract to the most concrete as an emergent process. Developing enterprise software becomes a process of growing knowledge the arrangement of which is inherent in the enterprise software ontology itself This should offer advantages far in excess of those provided by patterns imposed by any personal opinion. This inquiry must supply rules whereby ontological commitment may be placed in positions that must hold. Personal opinion must be ruled out as a reason for placement: the only help must come from a careful examination of the nature of enterprise software itself. This objectiveness of developing software reduces the reliance on experiences and subjective opinions. This accordingly gives new opportunities to accumulate learning and have cross projects comparisons.

Another distinct advantage is WBS being decoupled from product structure for the emerging character of the ontologies. Today's prevailing methodologies have product structure ingrained in the WBS and then allocated to responsible managers with budgets, schedules, and expected deliverables, a concrete planning foundation has been set that is difficult and expensive to change. A WBS is the architecture for the financial plan. Just as software architecture needs to encapsulate components that are likely to change, so must planning architecture. To couple the plan tightly to the product structure makes sense if both are reasonably mature. Decoupling is desirable if either is subject to change. With entity-based methodology, product structure emerges rather than being presupposed or assumed hence completely decouples from WBS.

Another distinct advantage is the scientific exactitude of calculating what tasks can be automated and what tasks must be performed manually. This advantage is offered by the mathematical logic that describes the types of theorem prover needed in deriving theorems at different levels of abstraction. This allows tools to be developed to automate all that can be automated and offers precisely the conceptual guidance for manual tasks. This scientific exactness in the use of tools has the potential to obsolete competitor tools in the marketplace.

Still other objects, features and advantages of the present invention will become readily apparent to those skilled in the art from the following detailed description, wherein is shown and described only the preferred embodiment of the invention, simply by way of illustration of the best mode contemplated for carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive, and what is intended to be protected by Letters Patent is set forth in the appended claims. The present invention will become apparent when taken in conjunction with the following description and attached drawings, wherein like characters indicate like parts; and, which the drawings form a part of this application.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram illustration of a living system within its surrounding world

FIG. 2 is a block diagram of illustration of the language the living system uses to communicate with its environment

FIG. 3 is a block diagram illustration of a mathematic representation of the living system

FIG. 4 is a block diagram illustration of the conceptual representation of enterprise software

FIG. 5 is a block diagram illustration of relationship between enterprise software and its embedded software system

FIG. 6 is a block diagram illustration of mathematical representation of enterprise software

FIG. 7 demonstrates the artifacts of enterprise model

FIG. 8 demonstrates the artifacts of business model

FIG. 9 demonstrates the artifacts of agent model

FIG. 10 demonstrates the artifacts of functional model

FIG. 11 demonstrates the structure of business process

FIG. 12 is a block diagram of requirements schema

FIG. 13 demonstrates the conceptual diagram of an axiomatic method

FIG. 14 demonstrates the conceptual diagram of the enterprise software development process

FIG. 15 is a block diagram of the system of the present invention

FIG. 16 is a block diagram showing the interrelationships of the modules making up the system

### DETAILED DESCRIPTION OF THE INVENTION

The objects, features and advantages of the present invention will become apparent to one skilled in the art, in view of the following detailed description taken in conjunction with the drawings. In the following detailed description, specific details are set forth in order to provide a thorough understanding of the invention. However, it will be understood by those of ordinary skill in the art that the invention may be practiced without these specific details. The new theoretical foundations, including the theory of Autopoiesis and mathematical logic, the decomposition of requirements engineering problem into standalone sub-problems, and their axiomatic theory based solutions will remain the same. The methods, software tools, systems, and conceptual tools evolve over time and are not to be followed as they are.

### The Machine—World Problem

Michael Jackson [Jackson, Michael, 1995] refers software as a machine and the environment surrounding the machine as the world as described in FIG. 1. The machine differentiates itself from the world by having a boundary. The boundary divides those elements as within the boundary to be parts of the machine from those elements in the world. It is an easy matter to redraw the boundary on paper at a very early stage of development. As a project progresses, the boundary becomes embedded in the design concept, investment is made, and it becomes progressively more difficult to alter the position of the boundary.

Russell Ackoff differentiates two types of environment for a system 011 [Ackoff, Russell, 1999]. The environment of a system consists of those things that can affect the properties and performance of that system is said to be transactional 013. That parts of a system's environment that can neither be influenced nor controlled is said to be contextual 012. Transactional environment contains customers and other systems that have dynamic exchanges with the system. Contextual environment contains the rules that constrain the entities within the transactional environment as well as the interactions between the system and its transaction environment.

The machine interacts with its environment. The interactions consist of the sharing of some phenomena—events and states—between the machine and the environment. Phenomena are what appear to exist, or to be present, or to be the case, when you observe the world or some part of it in a domain. These shared events and states form the interface between the machine and the world. This is specification interface: specifications are all about—and only about—the shared phenomena—the shared events and states—at this interface.

Requirements are all about—and only about—the transactional environment phenomena. The customer of the machine is interested in the environment, not in the machine Some of the customer's interests may perhaps accidentally concern shared-phenomena at the specification interface. But that would be accidental as far as requirements are concerned.

Programs, on the other hand, are all about—and only about—the machine phenomena. Programs are about the behavior of the machine. Programmers are interested in the machine's behavior.

Specification is both a requirement and a program. It is requirement because it's about—and only about—the environment phenomena. And it's a program because it's about—and only about the machine phenomena. That is why specifications, in this sense, form a bridge between requirements with programs.

Michael Jackson pointed out that entities and events to be considered at requirements engineering time pertain to the real world surrounding the software to be developed. He argued that specification should consider the system as a model of the world, rather than start from system functions. Analysts should explicitly model the reality and then derives the specification from that model. In effect, the system becomes a simulation of the real world, and derives its information directly from its model, and only indirectly from the world. It means that we should model the real world and then embody that model in the system to be developed.

The requirements specification is derived from the model of the world by a number of reasoning steps. We first model the world and then decide the parts of the model to be performed by the machine. The specification represents the answer to the question: what behavior at the specification interface would satisfy the entire model that in turn produces these effects required in the world or transactional environment? Therefore the specification is constructed based on the model of the world. When the world departs away from the model, the specification would not produce the desired effects in the transactional environment.

Not all requirements, the phenomena in the transactional environment, are shared with the machine. Specification describes functions in the transactional environment to be automated by the machine. In general, this opens up a gap between the requirements and what the machine can achieve directly, because the customer's requirements aren't limited to the phenomena shared with the machine. To justify an eventual claim that the program satisfies the requirement, we need to reason in following two steps:
Step 1, if the computer behaves as described by the programs P and P is programmed as specified by S, then the specification S must be satisfied.
Step 2, if the specification S is satisfied, S will satisfy the model of the world. If the world conforms to its model, the requirements R must be satisfied.

The key question becomes in what way should the truth of S ensure the truth of R? The answer is in our ability to model the transactional environment and the conformability of the transactional environment to the model. By construction, if S is true, the model is true. If the world conforms to the model and S is true, it follows that R is true.

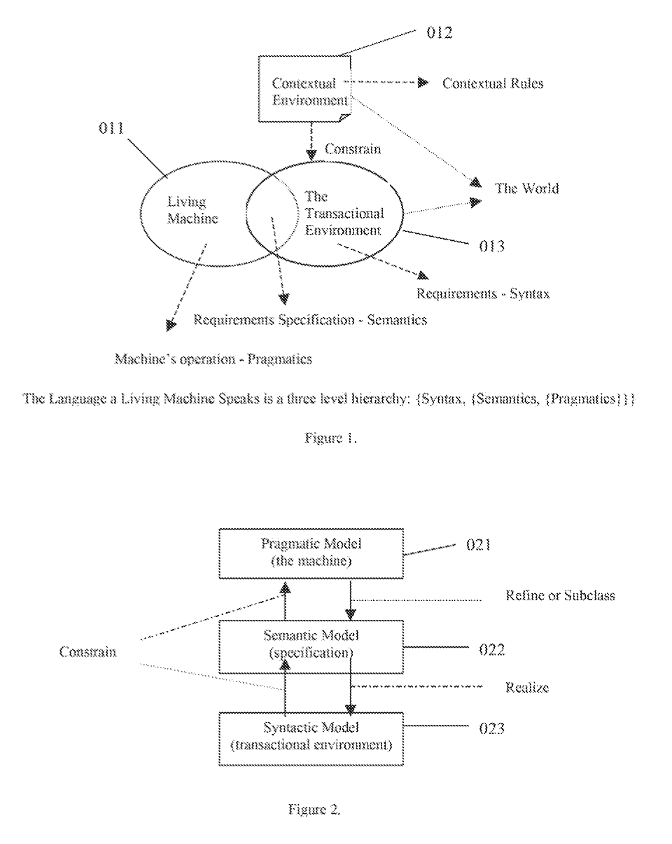

The model of the world, specification, and machine design correspond to syntactic model 023, semantic model 022 and pragmatic model 021 of the living systems view respectively. FIG. 2 describes the relationship between the three models. The higher model depends on the lower one while the lower model is independent of the model above.

For the living machine, the concept of real world is a complementaristic conception in the form of hypothesis (syntactic model, the description of the world), described as “a real world exists independent of us”, with an intended interpretation (the semantic model, the interpretation of the description in relation to the machine), or hypothetical content, that explains the meaning in terms of concepts in the shared language [Lars Lofgren, 2004]. That is, the real world is a complementaristically conceived as “semantic-like”, with a full interpretational content together with a correspondingly diminished, but unavoidable, residual descriptional or syntactical content, reduced to mere name. The description of the world, the syntactic model, is constrained by the capability of, and the relevancy of the part of the world to, the living machine. The interpretation of the world in terms of dynamic relationships between the world and the machine, or the possibilities of the machine, is also constrained by the description, the syntactic model. The entanglement between the description and interpretation or between syntactic and semantic models is linguistic complementarity. From the theory of Autopoiesis, the linguistic complementarity is encoded in the organization of the living machine.

The process of deriving semantic model from syntactic model is creating knowledge while the process of deducing pragmatic model from semantic model is applying knowledge. The process of designing a machine comprises two steps: creating knowledge (from syntactic model to semantic model) and applying knowledge (from semantic model to pragmatic model). Creating knowledge is generating insight through a process of extracting information from data as the creation of new patterns. Applying knowledge is realizing the new patterns as a process of refinement or subclass.

FIG. 3 is the mathematic representation of the machine world problem. The problem is decomposed into two sub-problems: requirements problem and design problem. The two solutions are two axiomatic theories: requirements and machine. The syntactic model 033, the syntactic rules 035, and the semantic model 032 are axioms, inference rules and theorems respectively of the machine requirements theory 036. The semantic model 032, semantic rules 034 and pragmatic model 031 are axioms, inference rules and theorems respectively of the machine theory 037. Syntactic model contains accepted assertions as true statements. Semantic model is deduced from syntactic model as theorems that become axioms for the machine theory where pragmatic model is derived. Requirements theory represents the whole of requirements of the machine. Machine theory translates the whole of requirements into technical explanation, the embodiment of the machine that realizes the requirements.

Enterprise Software as Living Unity with Living Unities within

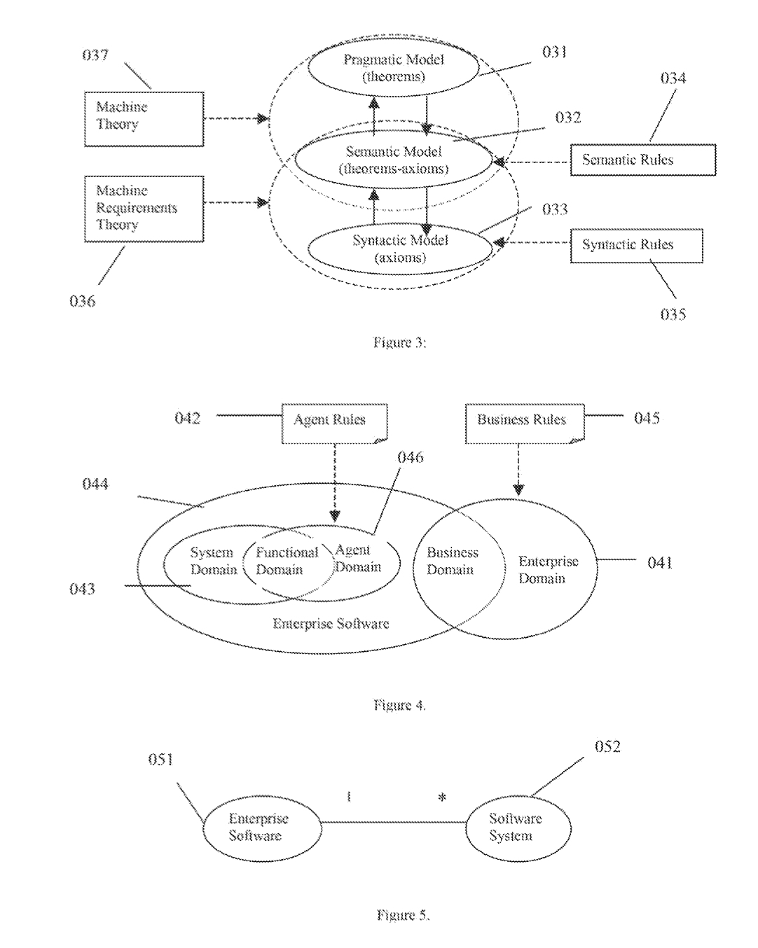

FIG. 4 describes enterprise software, a living unity (we may called it a living social machine) 044. In general, the relationship between the machine and its environment 041 is clear. The social machine is introduced into the world to have some effect there. The part of the world, the transactional environment that will affect the machine and will be affected by it, is the enterprise domain. Customers in the enterprise domain have their needs met by the machine. Customer needs are all about, and only about, the needs of the customers including the products and service they receive as well as information exchanges with other systems.

The social machine interacts with its environment, the enterprise domain, to produce and deliver products and services to the customers. The interaction consists of the sharing of some phenomena, forming the interface between the enterprise software and the enterprise domain. It is a specification interface that contains business processes. Those business processes deliver products and services to the customer. The specification represents the answer to the question: what behavior at the specification interface would produce these effects that are required in the enterprise domain?

The contextual environment of the social machine contains the contextual rules 045 such as government regulations and industry standards that constrain the interactions within the interface. The social machine comprises of human and nonhuman agents. These agents interact with each other, realizing these business processes. Nonhuman agents may include digital or analog devices, software agents etc. In general, there is no difference in the ability of technology, humans, or other nonhumans. They are called actants, forming an agent domain 046. Each actant performs distinct capabilities. Identifying capabilities and assigning them to appropriate actants is the subject of organization design. It answers the question of how to design the social organization to implement the business processes as efficient as possible?

The contextual environment of the software system contains agent rules 042 that constrain the behavior of the agents. Some of the agent rules realize the business rules 045 in implementing the business processes and some of the functional rules 047 realize agent rules. The agent domain becomes the world surrounding the software system 043 to be developed. The software machine interacts with its agent domain, the transactional environment, to augment certain capabilities needed by some agents. The interactions consist of the sharing of some phenomena, forming the interface between the software and the agent domain. We develop a software system to satisfy these requirements. The software system, as a machine, is introduced into the agent domain to produce certain effects there.

The agent domain contains the whole of requirements of the software system. Requirements are all about—and only about—the phenomena of the agent domain. Requirements specification is about the shared phenomena between the software system and agent domain. When events in the interface happen as designed, requirements are met.

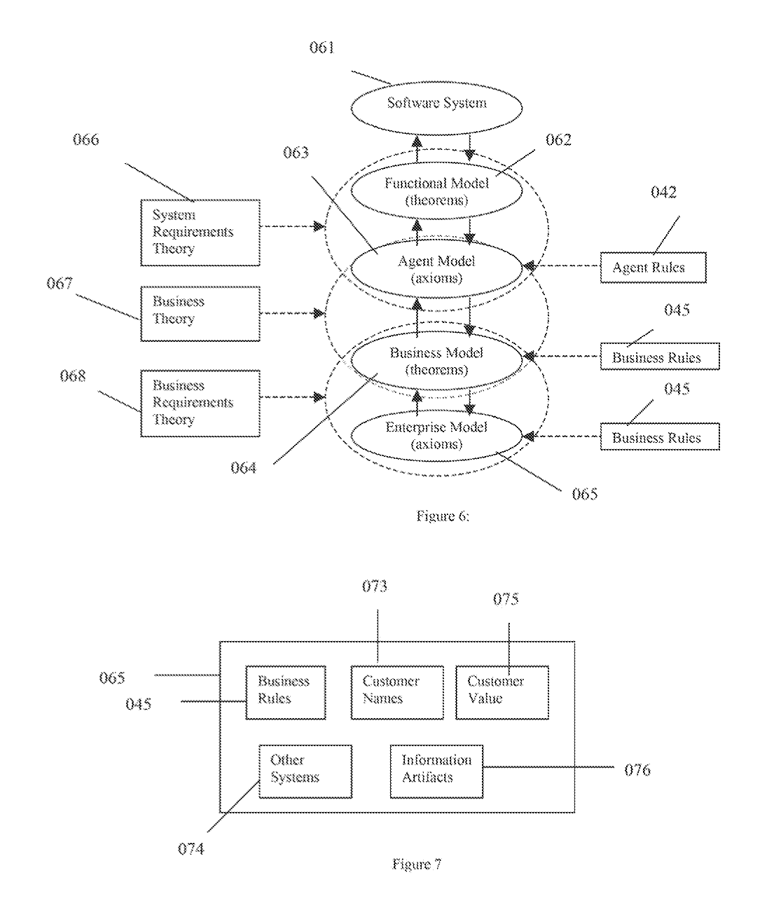

FIG. 5 describes the relationship between the enterprise software 051 and the software system 052. An enterprise-software may contain many software systems. These software systems implement functions required by the enterprise software.

FIG. 6 describes the mathematical representation of the enterprise software. As can be seen, a software system is a machine embedded in the enterprise software social machine. As a machine, enterprise software is represented in two axiomatic theories: business requirements theory 068 and business theory 067. The agent domain, represented as agent model in the business theory, becomes the world of the software system from which the syntactic model of the software system is identified. The two theories of a software system are system requirements theory 066 and system theory. For the scope of this invention we stop at system requirements theory. The goal of the invention is the complete requirements documentation at both enterprise and system levels.

FIG. 7 describes the enterprise model 045. The model, as one embodiment of the invention, contains business rules, customer names 073, customer value 075, other systems 074, and information artifacts 076. Common sense of rule is to remove some degree of freedom. A business rule is to remove some degree of freedom of, or constrain, customers for their eligibility to receive customer value. A business rule is a simple statement that expresses the rule.

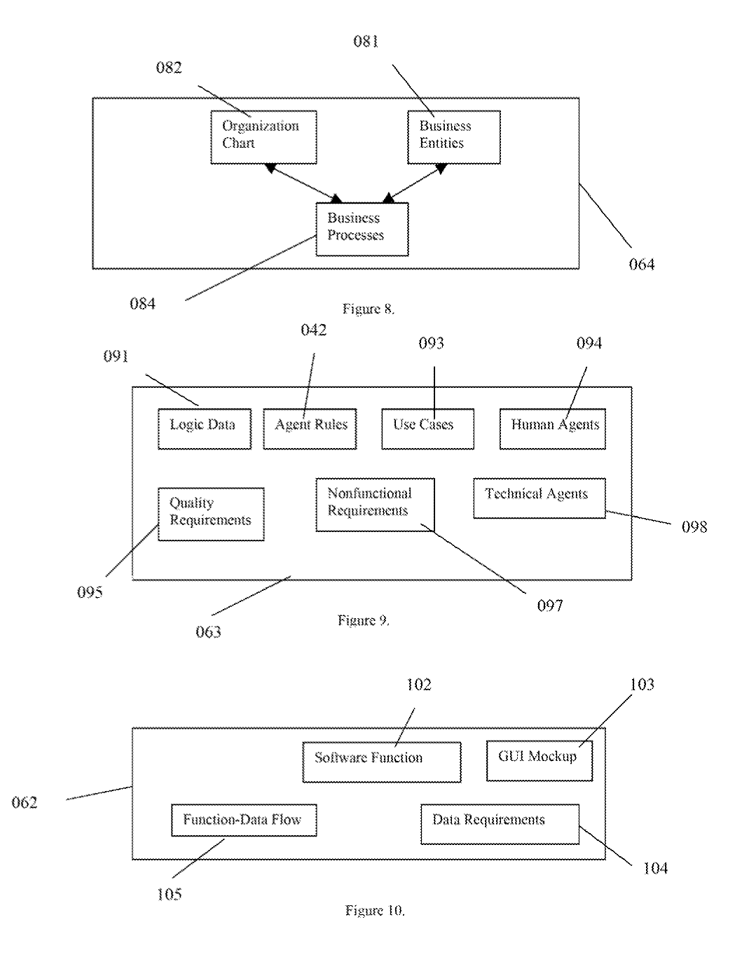

FIG. 8 describes business model 064. The model, as one embodiment of the invention, contains organizational chart 082, business processes 083, and business entities 081. Business entities are information or physical objects that the business processes create and consume. Organization chart is the management structure consisting of three main factors: hierarchy, span of control and decision-making. Hierarchy refers to the number of levels of management and supervision. Span of control refers to the number of people report to one manager or supervisor. An organization is centralized to the extent that major decisions, control over resources and authority to take action are in the hands of only a few top people; it is decentralized to the extent people at lower levels are able to make decisions, control resources and take action in their part of the organization. So an organization chart is a list of organizational units within which position titles are arranged based on the management structure.

A business process is a structured, measured set of activities to achieve a defined business outcome such as delivering a product or service to a customer. Business processes have two important characteristics: (i) They have customers (internal or external), (ii) They run across organizational boundaries, i.e., across or between organizational subunits. Business processes may be defined along three dimensions:
Organizational units: Processes take place between organizational units
Entities: Processes result in manipulation of entities. These entities could be Physical or Informational.
Activities: Processes could involve activities that operate on objects (e.g. fill a customer order).

Processes are generally described in terms of beginning, end points, and in-between activities. They begin and end with customers to deliver a product or service. They are what businesses, not individuals, do. Business processes are differentiated as core from non-core. Core processes directly relate to the organization's mission. Non-core processes may still be important but they aren't directly related to the mission.

A business process is broken down into sub-processes, and tasks. Therefore a business process can be described as a composition hierarchy [process [sub-process [task]]] as [whole [part]]. Sub-process is also a process. Tasks are smallest units of process breakdowns. When discussing business processes, it is important to differentiate process type from process instance. Process type is a class and process instance is an occurrence of the class. Business process model is the total number of identified business process types. Process instance or occurrence, is used to pinpoint particular process, like:
Processing a sales lead that concern a particular customer
Processing insurance claim #12345

Process occurrences involve particular actors in the use of the system under development. For each process type, there could be multiple process instances for the use of different tools. Process occurrences are presented as use cases to be modeled after. Business processes must be modeled to satisfying following criteria:
1. Business processes should be independent from each other. Interactions between processes are asynchronous in way of message exchanges. No direct interactions between activities across processes.
2. Business processes may have preconditions that maybe post conditions of other processes.
3. Sub-processes and tasks are candidates for reuse across enterprise.

A typical business organization serves a number of different kinds of customers and provides a number of different kinds of services and products; therefore there are different kinds of business processes for the business organization. The total number of business process types within a business organization can be enumerated by relating customer types with products and services types. A business process model captures all the business process types.

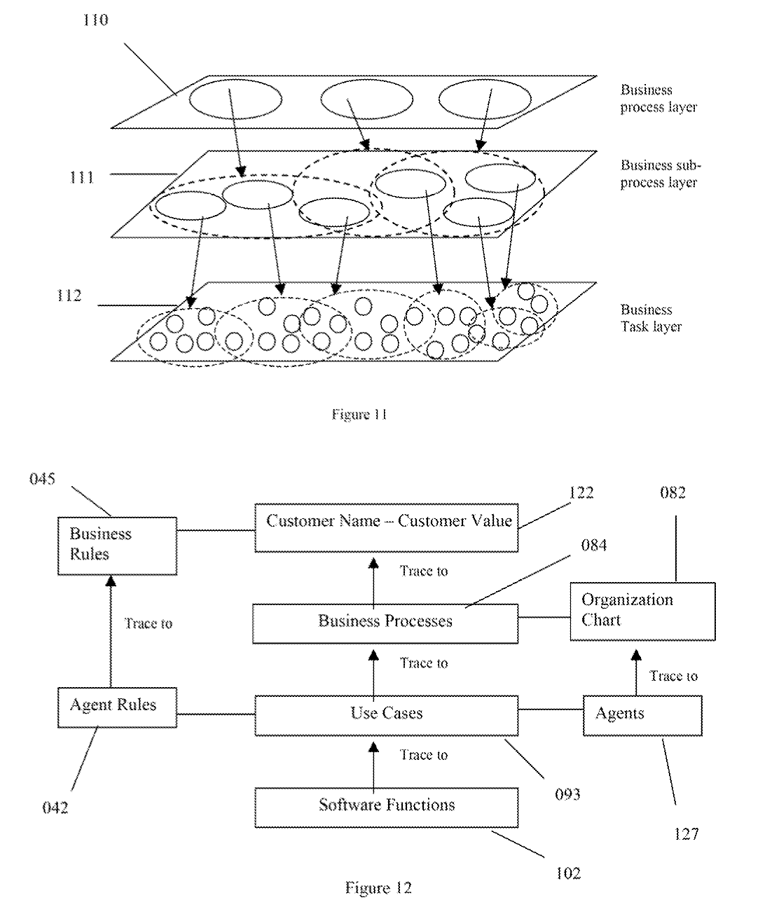

FIG. 11 describes one embodiment of business process architecture. The three levels are process layer 110, sub-process layer 111, and task layer 112. The composition hierarchy is one of parts nested within wholes (i.e. [cell [gene [molecule]]] or [sentence [word [letter]]] where [high level [low level]]). Each part at a level is a composition hierarchy itself. This hierarchy is quantitative construct where the number of components at each level can be counted. Complex systems often take the form of composition hierarchy as their mode of organization. Hierarchic organization shares some common properties independent of their specific content. Components at different levels differ in size by orders of magnitude and operate at frequencies of different scale. The lower the level, the higher frequency of intra-component interaction, and the more stable of the components are. Operating at different orders of frequencies, components at different levels do not interact dynamically or exchange energy but transact by way of mutual constraint. Organic molecules constrain the actions of their constituent atoms but do not exchange energy with protons and neutrons of the atomic nucleus. Each component performs its functions in ignorance of the detail of activity of other components. Intra-component linkages are general stronger than inter-component linkages at the same level. Inter-component linkages become weaker as levels move up.

One distinct character of the composition hierarchy is that it maximizes levels of abstraction and separation of concerns at each level of abstraction—the two sought after principles in software engineering. The levels of abstraction tie in all available software technologies today—business process management at top level, service orientation at middle level, and object orientation at bottom level. The rise of abstraction raises developer's productivity, improves software quality, and increases software longevity. By maximizing the separation of concerns at each level, it provides a host of crucial benefits: additive, rather than invasive change; improved comprehension and reduction of complexity; adaptability, customizability, and reuse; simplified software integration; and the ultimate goal of “better, cheaper, and faster” software.

FIG. 9 describes an embodiment of agent model 063. Use cases 093 are business process instances. Agent rules dictate how the instances of a given process type should be run along two dimensions: people (not organization units) and objects. Constraint on the behavior of people is operative rule. Constraint on objects is structural rule. Structural rule is built-in (i.e. “structural”, “by definition”). For operative rule, people may still potentially violate the rule—hence appropriate enforcement and discretion. Quality requirements are constraints of business process instances that are part of use cases.

FIG. 10 describes an embodiment of the functional model 062 that contains four deliverables: data requirements 104, software function 102, function-data flow diagram 105, and GUI Mockup 103. Data requirements include logical data model as well as data security categorization, access control, privilege control, and logging. Software functions specify the functions to be implemented by the software system. They convert business processes (business logic) through the use cases into software processes (software logic). Software functions describe particular system behaviours, such as data change, calculation or processing whereby a use case is fulfilled. As part of this activity the requirement is documented so as to enable understanding of why it is needed and for tracking throughout the software development process. Software functions may contain other functions. Each function is tied to quality requirements as a way of performing the function. Software functions have data inputs and outputs as well as algorithms. The function name should help indicate the function purpose. Data flow diagram describes relationships between software functions and data, data source, data flows, and data sink.

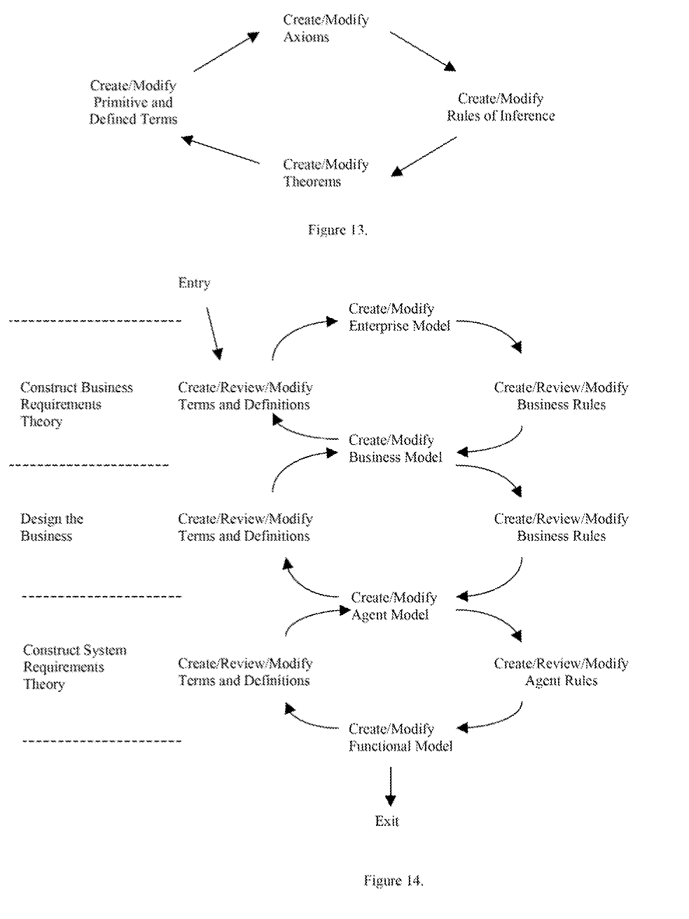

FIG. 12 describes a requirements schema for representing how different types of requirements are related as an example. This structural relationship of different requirements types is used as grammar for computer to check and report anomalies of the requirements stored in the database. The grammar is used for model checking to ensure consistency, completeness, and coherence of these requirements. The requirements schema contains only the engineering requirements artifacts that will remain in the entire product lifecycle. Project and management artifacts such as test cases, project plan, schedules, and work breakdown structures are discarded after the project completes hence are not part of the requirements schema. The schema illustrates several main requirements types and their relationship. There are four levels in this requirements schema. The four levels represent four domain's ontologies: enterprise, business, agent and software system. “Customer Name—Customer Value” 122 is derived from enterprise domain model as a simple statement. An example is “Customer A needs service B under the constraint C” where A is customer name, B is customer value and C is a business rule. For each such statement, there is a business process 123. Business process is represented as a composition hierarchy in FIG. 11. For each element in the FIG. 11, there is a use case 124 corresponding to it. There could be use cases that do not trace to business processes. These use cases include administrative functions that are necessary for better efficiency. Some of the use cases lead to software system. These use cases are identified whereby software functions 125 are abstracted out. The software functions will be translated into software system architecture.

Because business process is a composition hierarchy, so are use cases and software functions. This hierarchical structure is a major facilitating factor enabling us to understand, describe, and even “see” such systems and their parts. If there are important systems in the world that are complex without being hierarchic, they may to a considerable extent escape our observation and understanding. An analysis of their behavior would involve such detailed knowledge and calculation of the interactions of their elementary parts that it would be beyond our capacities of our memory or computation. This understandability of hierarchical structure is due to its high degree of redundancy, hence can often be described in economical terms. The analysis of a hierarchical system begins with a few basic elements or alphabets that are combined into a few subsystems at the next level that are in turn further combined into larger subsystems at a still higher level and so on. Most of the complex structures found in the world are enormously redundant, and we can use this redundancy to simplify their description. By following certain principles these subsystems can be made loosely coupled. We can then study these subsystems independently at each level without worrying much about their coupling with other subsystems at the same level and systems at both lower and upper levels, thereby further simplifying the overall system's understanding and development.

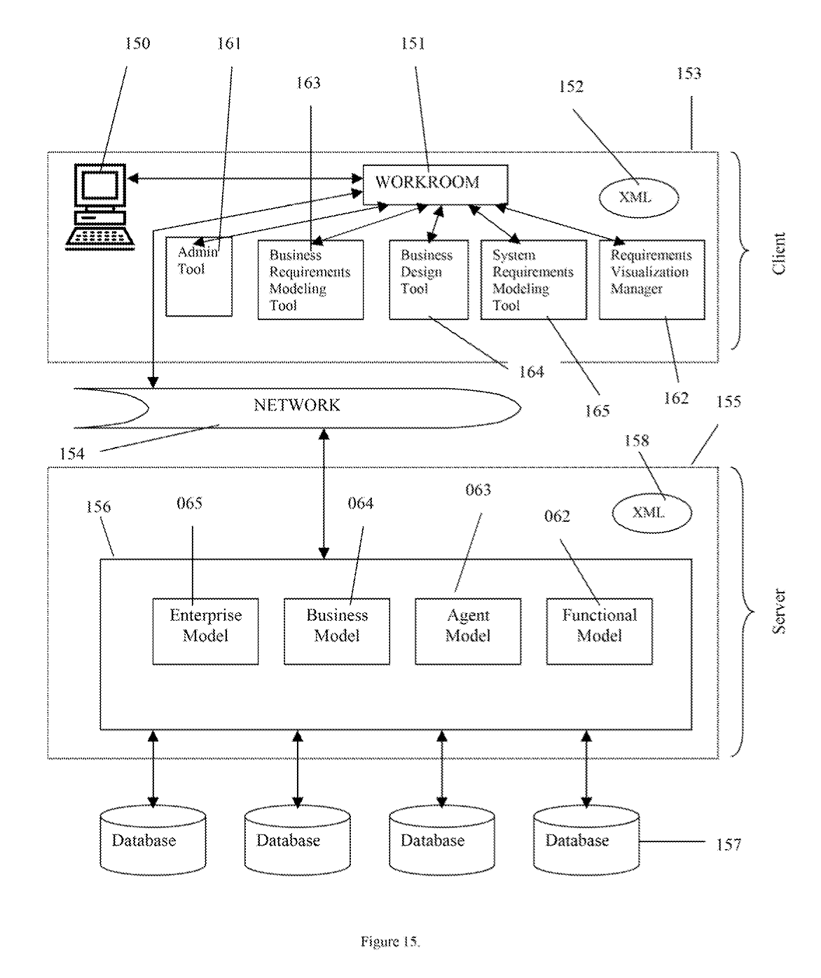

The requirements engineering problem is decomposed into three sub-problems each of which is solved by creating an axiomatic theory using axiomatic method. FIG. 13 describes axiomatic method that contains four steps. Axiomatic method involves replacing a coherent body of propositions (i.e. business processes) by a simpler collection of propositions (i.e. customer name). In mathematics, axiomatization is the formulation of a system of statements (i.e. axioms) that relate a number of primitive terms in order that a consistent body of propositions may be derived deductively from these statements. Therefore, the proof of any proposition should be, in principle, traceable back to these axioms. There may be theorems that are proved without using any axioms. But all axioms should be used to derive theorems or all axioms should be traced from theorems to satisfy completeness requirements. By constructing formulas with axiomatic method, these formulas are automatically consistent and correct. By abiding the rule of all axioms being used for deriving theorems, we have a theory that is complete (i.e. no missing requirements).

One of the primary advantages of the present invention is the ability to decompose the requirements problem into three standalone smaller problems. The solution to each problem is an axiomatic theory. Therefore the entire solution to requirements problem is three hierarchically organized theories. The subset of the theorems of the previously created axiomatic theory becomes the axioms for the axiomatic theory at next level. FIG. 14 represents the entire process of creating three axiomatic theories.

In logic, a procedure by which a theory is generated in accordance with specified rules by logical deduction from certain basic propositions (axioms), which in turn are constructed from a few terms taken as primitive. These terms and axioms may either be arbitrarily defined and constructed or else be conceived according to a model in which some intuitive warrant for their truth is felt to exist. By conceiving software development as a series of axiomatic theory construction and what we create are axiomatic theories nothing but axiomatic theories, we are assured that what are constructed are mathematically precise and therefore the most economical.

The present invention implements entity based methodology that is radically different from today's prevailing methodologies seen in the marketplace. The axioms and theorems of each axiomatic theory are grouped as loosely coupled business artifacts. Each business process (a composition hierarchy), for example, is a business artifact or a body of business artifacts. The central notion is that “what the business actually does” can be described by using the concept of artifacts and associated network of tasks through which artifacts flow. A business artifact is a piece of concrete identifiable chunk business information that makes sense to a businessperson. Business artifacts, or semantic objects, are a mechanism to specify and produce business information in units that are concrete, traceable, extensible, self-describing, indivisible, reusable, composable, and encapsulated. Therefore a business artifact is an information object written to specification according to a specified template. Business artifacts are what workers produce with assistance of software tools and thinking tools. Examples of thinking tools include worksheets and principles used by business or IT workers to collect business data and create artifacts. The conversion from business data to business artifacts may be automated using software tools that generate deliverables based on specified document templates.

Each artifact is associated with information accounting. This means asking questions as to what information is available in the artifact that starts the task, what information must be added in order to accomplish the goals of the task, where the information comes from, and what tacit knowledge required to produce that artifact. The information that is added is either created by the task or comes from another artifact in the network that the task must acquire in order to complete the processing. A caveat that is significant when designing tasks is that a task has no knowledge of the tasks that may precede it or follow it; a task has to work with the information that is contained in the artifacts in its possession. Once a task completes all the artifacts on which it is working, it ends. A task has no business state as such; all such states are carried in the artifacts.

In the context of requirements engineering, entity based methodology (comprising three axiomatic methods) is used for modeling technique that would be not only amendable to business and IT people and intuitive for business communications, but also based on a formal structure suitable for use in rigorous design and design analysis. The core objective is to create a representation that both business and IT people could use to analyze, manage, and control their tasks from day to day. This is possible as ensured by the ontological commitments whereby people with different specialties are able to produce artifacts and communicate. Entity based methodology is the basis for the factorization of knowledge into artifacts, tasks, and flows. It begins with the representation of artifacts from which tasks and flows are identified based on the structural relationship between artifacts. The incarnation of artifact, task, and flow in an instance of software process is represented in a unified manner at a uniform level consistent with business semantic use. It is the completeness and dependencies of the artifacts that determine the goals, processes and tasks in the design of software development methodology.

Referring now to FIG. 15. The system of the present invention is illustrated in block diagram form. For ease of understanding, the system is illustrated in two parts. First, there is a client as bounded by a dashed line and a server, also bounded by a dashed line. The client 153 and server 155 communicate with one another over a network 154. The network 154 may comprise any conventional network (i.e. TCP/IP), or the Internet. A user interface 150 is coupled to a workroom 151 and both are shown as part of the client, The workroom 151 is a front end component of the system of the present invention and is coupled to the network 154, which is coupled to a repository 156. In the disclosed embodiment, the repository 156 is a specialized, extensible database application that adds value to a database system, which allows extension for further customization (such as application development). The repository 156 is coupled to databases 157 etc. for accessing modeling data stored therein. The repository 156 further includes methods for cataloging, browsing, modeling, and managing components that make up an application. Methods to support these services are implementation details. Tools 161 through 165 (within the client 153) are coupled to the workroom 151 and are disposed for performing a variety of tasks. Tools 161-165 are linked to the repository 156 by means of an XML that is disposed within the Client 153. XML is typically used to enable access, via the Internet protocol, to information stored in databases. Moreover, some tools may be coupled to another XML tool 158, which is disposed within the server 155 for running server components. XML is typically used for message exchanging in the proper format.

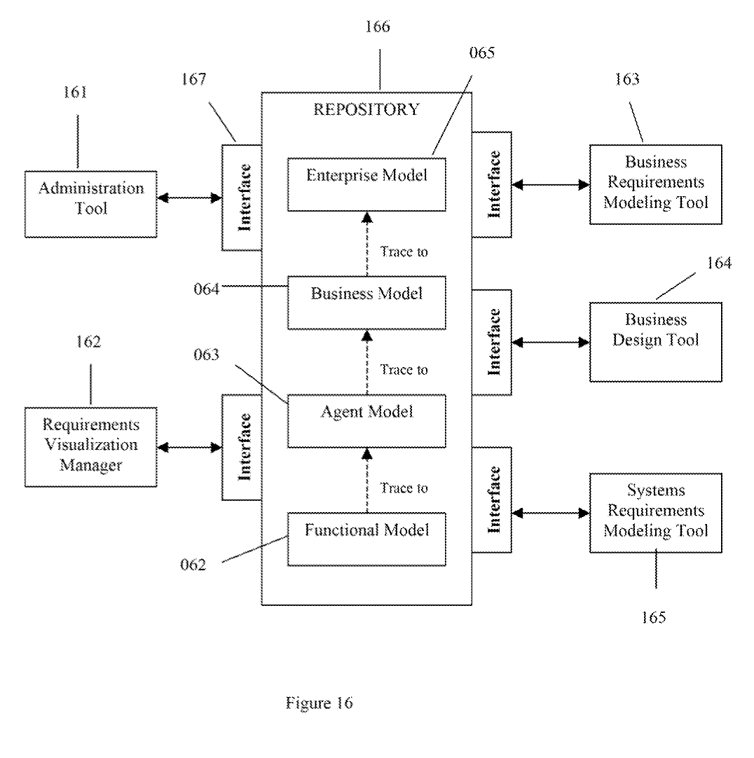

Referring to FIG. 16, the interrelationships of the modules making up the system supporting the new methodology of the present invention are show in a block diagram. Included in the repository 164 are the four domain models. The modeling languages could be chosen appropriate to each type of model. Business model, for example, may use BPMN and Agent model may be written in UML with extensions. The tools are coupled to the reposition through interfaces. The interfaces 167 are typically an XML tool. A major advantage of the system in this invention is the ability to link or trace from between the four models that make it easy to visualize the requirements and analyze impacts of changes from anywhere in the four models.

One embodiment of the invention reflected in the FIG. 16 is model transformation to construct requirements. That is, requirements engineering process is viewed as a function.

Y=F(X).

### Where,

Y is the output, the functional model 062.
X is the input, business requirements axiomatic system that includes the enterprise model 065 and business rules 045.
F is the function of a series of logic deductions.

Business model 064 and agent model 063 are intermediate variables of the process. The requirements engineers' goal is to create and transform these models as efficient as possible. How well to achieve this goal depends on how well the process knowledge is mastered. The process knowledge includes understanding of and relationships between these four models. Each model is described using a well-formed language. The more complete understanding on these models and their transformations, the better process knowledge and the better we are able to control. These models are derived through logic proof in creating axiomatic theories. The objectiveness of the function F implies that requirements are derived with subjective certainty without the placement of personal opinions. It means that we can construct precise, complete and stable requirements upfront.

### An Example—Interment Scheduling System

A national cemetery needs to update its systems that support its main business process: interment-scheduling process. It has about ten clerks answering nearly a thousand phone-calls and conducts thirteen funerals daily. Activities include gathering personal data, verifying eligibility, background check, scheduling funeral, and managing resource etc. The business processes are constrained by many business rules such as eligibility for bury (civilians, veterans, veteran dependents as well as group bury etc) and types of resources (i.e. gun salute, caisson etc) qualified for etc.

If this project was approached with today's prevailing strategy, we'd begin with a list of features, what the system shall do. More than likely, there would be problems: missing requirements, rework, and software business misalignment. Derving complete, precise requirements upfront would be infeasible with current frame of thinking but becomes obtainable with CbyP by using the function below.

Y=F(X).

X contains the enterprise model and business rules that are objectively determined. The enterprise model is identified with seven types of customer. They are deceased veteran, related military, related civilian, and group interment etc. Each is associated with a set of business rules. There is only one service that is funeral service for types of customer. Therefore the number of business process types is eight. This will cover all possible scenarios even those that are not frequently used such as group bury. The eight types of customer constitute part of the transactional environment of the enterprise software, forming the boundary of the project. Through three steps of logic deduction, we derive the functional model from the enterprise model objectively through business and agent models that are intermediate variables. It constructs the entire requirements by proof, achieving the goal of precise, concise and stable requirements upfront.

This example illustrates that requirements normally do not change. It is our understanding of requirements that keeps changing. When we change our method, we change our way of understanding and accordingly we change requirements quality. By following the methodology CbyP proposed in the invention, we are able to do the right thing at the right time, eliminating scope creep and requirements change problem. CbyP maximizes the business understanding systematically in the beginning, gains customer satisfaction and approval early, and lays a solid foundation for the following development activities. Documentation was concise, precise and complete with far little cost related to expansion and change. CbyP is simple enough that any software companies can follow to achieve better, cheaper, and faster all at the same time. Given the fact that 25%-40% of all spending on a project is wasted due to rework. CbyP saves most if not all rework cost related to requirements instability and ensures customer satisfaction and opportunity.

### Summary

The present invention has been described with reference to diagrams of methods, requirements definitions, and models as well as systems and computer program products according to the embodiments of the invention. It is understood that what constitute business requirements theory, business theory, and system requirements theory are implementation specifics and unique to each software project. The methods also differ from companies to companies and evolve over time. But the idea of the three theories to represent the whole of enterprise software requirements does not change. For the types of software other then enterprise software, the proposed invention also applies simply by reducing the number of theories or levels of models to meet specific situations. Being the most complex, enterprise software includes all that is needed to construct the whole of requirements. Therefore, the concept of syntactic, semantic and pragmatic models and their mathematic representations as well as epistemic methods will remain the same regardless of the type of software and their embodiments.

It will be understood that each diagram can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein.

These computer program instructions may also be stored in a computer readable memory that can direct a computer or other programmable data processing apparatus to function in a particular manner, such that the instructions stored in the computer-readable memory produce an article of manufacture including instruction means which implement the functions herein.

These computer program instructions may also be loaded onto a computer readable or other programmable data processing apparatus to cause a series of operational steps to be performed on the computer or other programmable apparatus to produce a computer implemented process such that the instructions which execute on the computer or other programmable apparatus provide steps for implementing the functions specified herein.

While it is apparent that the invention herein disclosed is well calculated to fulfill the objects stated above. It will be appreciated that numerous modifications and embodiments maybe devised by those skilled in the art and it is intended that the appended claims cover all such modifications and embodiments as fall within the true spirit and scope of the present invention. It is therefore contemplated that the appended claims will cover any such modifications of embodiments that fall within the true scope of the invention.

Having thus described the invention, what is claimed is:

1. A method of defining enterprise software requirements, comprising:
creating business requirements axiomatic theory using axiomatic method;
creating business axiomatic theory using axiomatic method;
creating system requirements axiomatic theory using axiomatic method;

2. The method of claim 1, wherein said enterprise software is an organization, comprises:
a boundary differentiating itself from its environment and dividing those elements as within said boundary to be part of said enterprise software from those elements in said environment; said environment comprising transactional environment and contextual environment, wherein said transactional environment comprising internal, external customers, products/services the customers receive, and/or other systems; said contextual environment comprising constraints such as business rules;
said parts of enterprise software comprising human and nonhuman agents, policies, systems, and administrative functions etc, wherein said systems are software systems to be developed.

3. The method of claim 1, wherein said axiomatic method comprises:
creating and modifying primitive and defined terms;
creating and modifying axioms;
creating and modifying rules of inference;
creating and modifying theorems.

4. The method of claim 3, in deriving said theorems, all said axioms are used.

5. The method of claim 1, wherein axioms, inference rules, and theorems of said business requirements axiomatic theory are enterprise model, business rules, and business model respectively.

6. The method of claim 5, wherein said business model is a composition hierarchy.

7. The method of claim 5, wherein said enterprise model describes said transactional environment of said enterprise software, said business rules describe said contextual environment of said enterprise software, and said business model describes the interactions between said enterprise software and said transaction environment.

8. The method of claim 1, wherein axioms, inference rules, and theorems of said business axiomatic theory are business model, agent rules, and agent model respectively; said agent model is a complete design of said organization.

9. The method of claim 1, wherein axioms, inference rules, and theorems of said system requirements axiomatic theory are refined agent model, functional rules, and functional model respectively.

10. The method of claim 9, wherein said refined agent model contains new agents such as administrative agents.

11. The method of claim 2, wherein said software system comprises:
a boundary differentiating itself from its environment and dividing those elements as within said boundary to be part of said software system from those elements in said environment; said environment comprising transactional environment and contextual environment, wherein said refined agent model describes said transactional environment and said functional rules describe said contextual environment;
said functional model comprises the requirements specification of said software system.

12. The method in claim 2, wherein said enterprise software may comprise plurality of said software systems.

13. A method of defining enterprise software requirements using requirements function comprising:
input, output and intermediate variables wherein said input comprises enterprise model and business rules, said output comprises functional model, and said intermediate variables are business model and agent model as well as agent rules and functional rules;
a requirements model that relates said enterprise, business, agent, and functional models as a four-level hierarchy;
logical deduction from said input to said output along said requirements model.

14. The method of claim 13, wherein said requirements model is coherent whereby all elements of lower model are used to derive elements of the higher model;
said deduction from said lower to said higher model is a realization or refinement by means of proof.

15. The method of claim 14, wherein said deduction comprising procedures and guidelines and said guidelines and procedures evolve over time.

16. A system with a computer-readable medium having a repository therein and a framework for integrating requirements engineering modeling tools into said system, for defining and managing complete enterprise software requirements, said framework comprising:
enterprise modeling tool comprising means to create and store enterprise model;
business modeling tool comprising means to create and store business model;
agent modeling tool comprising means to create and store agent model;
functional modeling tool comprising means to create and store functional model;
requirements visualization and management tool comprising means to visually display constituent components of all four said models, means for generating various reports, means for tracing constituent components between said four models, and means for managing change impact of one requirement on all others;
administration tool comprising means to administer users and perform configuration management on said system;

17. The system of claim 16, wherein said repository comprising a requirements content schema and search capabilities.
